(19) United States
(12) Patent Application Publication
(10) Pub. No.: US 2003/0131277 A1
(43) Pub. Date: Jul. 10, 2003

(54) Soft error recovery in microprocessor cache memories

(76) Inventors: Richard D. Taylor, Eagle, ID (US); Greg L. Allen, Boise, ID (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/044,080

(22) Filed: Jan. 9, 2002

(51) Int. Cl. H04L 1/22

(52) U.S. Cl. 714/5

(57) ABSTRACT

A method and apparatus for protecting cache memories from soft errors. Entries in the cache's data store and tag memory are associated with parity bits. During a read cycle, the parity bits are checked and data retrieved only if the parity checks indicate no errors.

### FIELD OF THE INVENTION

This invention pertains generally to error detection and more particularly to cache memories using parity bits to protect against soft errors.

### BACKGROUND OF THE INVENTION

A processor's clock speed typically exceeds the access speed of its system memory. To prevent the slower access times of its system memory from impacting processing speed, processors use smaller but faster cache memories in addition to the system memory. A cache memory will have faster access times than the system memory so that its processor may read or write to the cache without suffering the delays presented by use of the system memory. Turning now to FIG. 1, a conventional level two cache memory 10 is shown coupling to its processor 12 over a system bus 14. A system memory 16 stores the operating system code for processor 12. During operation, processor 12 will read operating system instructions and data from system memory 16. Because cache memory 10 has faster access, processor 12 will first check whether the requested instruction/data resides in its cache 10 before reading from its system memory. A cache controller 18 determines whether the cache 10 has the requested system memory item (denoted as a “hit”).

Note that the system memory may be many megabytes in size whereas a data store 20 within cache 10 may store just a few hundred kilobytes. A predetermined scheme must be used to map the addresses of data in system memory 16 to the addresses of data within data store 20. Given this mapping, a tag memory 22 within cache 10 stores the system memory addresses of data stored in the data store 20. Thus, cache controller compares the system memory address of the requested data to that stored by the tag memory 22 to determine a hit. In this fashion, should a hit occur, processor 12 may access the data directly from the data store 20 rather than using system memory 16.

As a result of the faster access times, use of secondary caches such as cache 10 has become widespread. As technology advances, silicon geometries in caches continues to shrink, making caches more susceptible to soft error problems. In contrast to hard errors caused by hardware defects, a soft error is not repeatable. Instead, transitory disturbances such as alpha particles from radioactive decay cause a stored bit to be read with the wrong binary state, producing a soft error. Caches are particularly susceptible to soft errors because data may remain cached for a very long period (days or even years) while a device is in an idle condition. If a bit in an instruction cache becomes corrupted, a malfunction of the device is almost guaranteed. As a result, a number of techniques have been developed to provide soft error protection for memory caches.

For example, error correction circuitry has been used to detect and correct single and/or multiple bit errors. However, such circuitry adds significantly to the manufacturing cost. Moreover, the complexity of the error correction logic implemented by the circuitry may result in decreased performance. Because cache access time is so critical to system performance, systems using error correction logic in their caches will suffer accordingly. Another approach is to use more expensive packaging material with lower levels of radioactively-decaying impurities, thereby reducing alpha particle emission. However, in addition to adding cost, such an approach cannot completely eliminate malfunctions due to alpha particle radiation.

Another approach is to flush and disable the cache during idle periods to reduce the chance of soft error corruption. But flushing a large cache takes time and reduces system performance.

In an attempt to overcome the soft error problems, cache memories have been developed with parity bit error protection schemes. For example, U.S. Pat. No. 6,226,763 discloses a cache memory in which a parity bit associates with entries in the cache's tag memory. Although such an approach may be more robust to soft errors than the previously-discussed prior art approaches, it is still susceptible to soft errors occurring in the data store.

Accordingly, there is a need in the art for improved techniques for protecting memory caches from soft errors.

### SUMMARY

In accordance with one aspect of the invention, a cache includes a data store and a tag memory. Each entry in the data store has a corresponding entry in the tag memory. A parity bit memory stores a parity bit for each entry in the data store and for each entry in the tag memory. During a read cycle, the cache's cache controller checks the parity bit for the tag entry and, should a hit be indicated, checks the parity bit for the corresponding data store entry. Should both parity checks indicate no error, the corresponding data store entry is retrieved.

The following description and figures disclose other aspects and advantages of the present invention.

### BRIEF DESCRIPTION OF THE DRAWINGS

The various aspects and features of the present invention may be better understood by examining the following figures, in which:

FIG. 1 is a block diagram of a prior art processor having a cache, cache controller, and system memory.

FIG. 2 is a block diagram of a processor having a cache implementing soft error protection according to one embodiment of the invention.

FIG. 3 is a flow chart illustrating the steps implemented by the cache controller of FIG. 2 during a read cycle according to one embodiment of the invention.

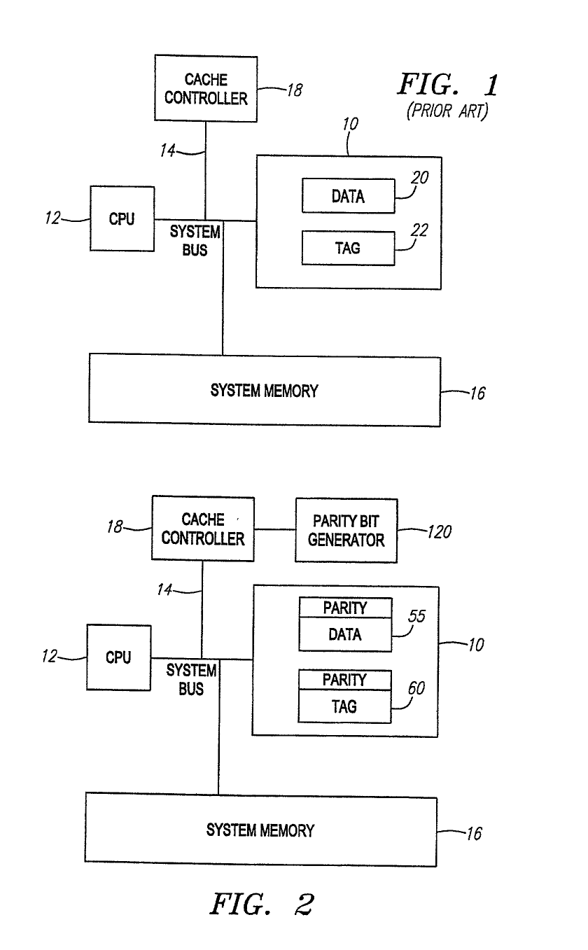

### DETAILED DESCRIPTION

FIG. 2 illustrates a processor 12 coupled to a cache 10 having soft error protection. Although the following discussion assumes cache 10 is a level 2 cache, the principles of the invention are equally applicable to primary caches and tertiary or greater caches as well. Cache 10 includes a data store 55 and a tag memory 60. Although shown separately, data store 55 and tag memory 60 may be integrated into a single memory (not illustrated). Because the access time of cache 10 is faster than the access time of system memory 16, when processor 12 requests a read from system memory 16, cache controller 18 will check to see if the requested data is stored in data store 55. Whether the data store 55 contains the requested data is generally referred to as a “hit.”

It will be appreciated by those of ordinary skill in the art that data store 55 is organized into cache lines each of which stores a certain number of bytes. If the capacity of data store 55 is M bytes and each line stores N bytes, the number of lines will be M/N. In the event of a hit, because cache controller 18 will typically return an entire cache line to processor 12. Accordingly, there are only MIN addresses for data store 55, one for each cache line. These addresses are mapped to the larger capacity of system memory 16. Suitable mapping techniques include direct mapping, fully associative mapping, or N-way set associative mapping. Regardless of the specific mapping technique being implemented, because the capacity of data store 55 is less than that of system memory 16, multiple memory locations in system memory 16 will map to or share the same location in data store 55. To enable cache controller 18 to determine if the requested data from system memory 16 is in data store 55, tag memory 60 provides the mapping from a data store line address to the actual address in system memory 16. Because data store 55 has M/N line addresses, tag memory 60 will also have M/N corresponding addresses.

Accordingly, to determine whether a hit exists, cache controller 18 will examine the requested system memory address and, based upon the system-memory-to-data-store mapping being implemented, determine which cache line address in data store 55 may correspond to the requested data. Cache controller 18 then checks the contents of tag memory 60 at this cache line address. The contents of tag memory 60 will determine which system memory location, out of the many that may share this cache line address, is stored on this cache line. Should the contents of tag memory 60 indicate a hit, the entire cache line is retrieved from data store and transported over system bus 14 to processor 12 to complete a read cycle.

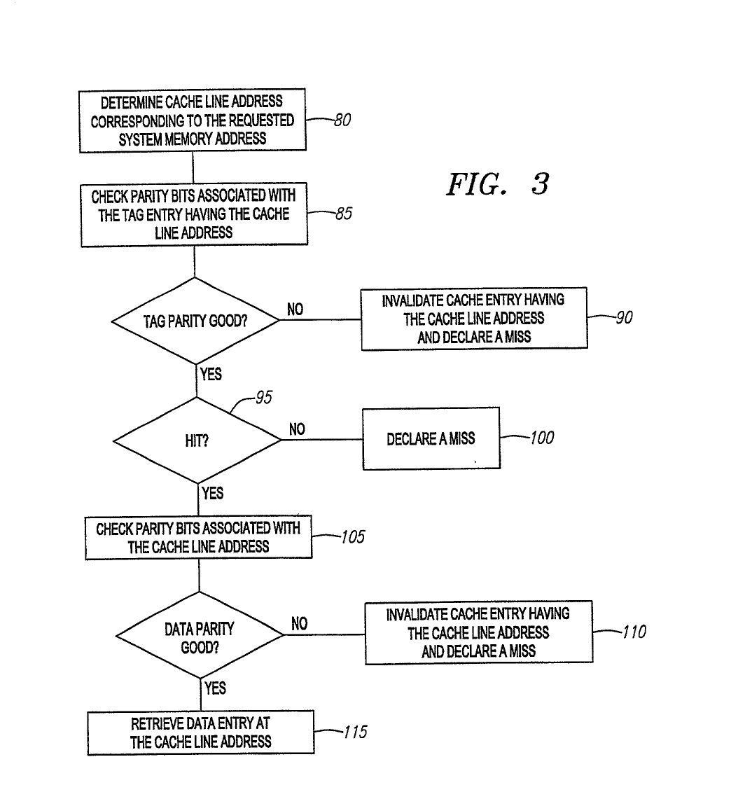

To provide soft error protection, each line in tag memory 60 and data store 55 associates with a parity bit or bits. If a single parity bit is used, the parity may be either odd or even. Turning now to FIG. 3, a flow chart illustrates the steps cache controller 18 may take to check these parity bits during a read cycle. At step 80, cache controller 18 determines the cache line address corresponding to the requested system memory address. At step 85, cache controller 18 checks the parity bit(s) associated with the tag entry having the cache line address in tag memory 60. If the check of the tag parity bit(s) indicates there is an error in the tag, the cache controller 18 invalidates the cache entry at the determined cache line address and declares a miss at step 90. Conversely, if the check of the tag parity bit(s) indicates no error in tag, the cache controller 18 determines whether there is a hit at step 95 by comparing the requested system memory address to the contents of the tag. Should the comparison indicate that the cache line will not contain the requested system memory data, cache controller 18 will declare a miss at step 100. Conversely, should the comparison indicate the cache line will contain the requested system memory data, cache controller 18 will check the data parity bit(s) associated with the cache line address in data store 55 at step 105. If the data parity bit(s) indicate an error in the data store 55, cache controller 18 will invalidate the cache line at the determined cache line address and declare a miss at step 110. Conversely, should the data parity bit(s) indicate no error, the cache controller 18 retrieves the data entry at the determined cache line address at step 115. Because a hit has been declared, the corresponding read from system memory 16 will be aborted. However, had a miss been declared, the corresponding read from system memory would continue and eventually return the requested data to processor 12 over system bus 14. Just as with data store 55, rather than return a single byte of data at the desired address, a chunk or line of data the same length as the cache line will be retrieved from system memory 16. It will be appreciated by those of ordinary skill in the art that the method illustrated in FIG. 3 may be implemented entirely in hardware, requiring no firmware support. Alternatively, the method may be implemented using software support as well.

In the event of a miss at any of steps 90, 100, or 110, cache controller 18 will write the line of data retrieved from system memory 16 to cache 10. Cache controller 18 determines what cache line address to store the retrieved line of data depending upon the particular mapping technique being implemented. In addition, cache controller 18 will generate the tag address that is stored at the same address as the cache line address in tag memory 60. Cache controller 18 also coordinates the writing of the associated parity bits generated by a parity bit generator 120. Parity bit generator 120 generates the parity bit(s) as determined by the particular parity scheme being implemented. For example, if even parity is chosen, parity bit generator 120 would count the number of “one” bits in the retrieved data line. If the number of “one” bits were odd, the associated parity bit would be “one.”Conversely, if the number of “one” bits were even, the associated parity bit would be “zero.” Should odd parity be chosen, the associated parity bit would be the complement of the even parity bit. It will be appreciated that a single parity bit(s) could be used for the combined tag and data parity. In such an embodiment, the parity bit(s) would be generated based upon both the retrieved data line and the tag. This combined parity bit(s) could be stored in either the data store 55 or the tag memory 60.

Data store 55 may be configured as either a write-through or a write-back data store such that not only reads from system memory 16 are cached but also writes to system memory 16 are cached as well. In a write-through configuration, each write cycle to system memory 16 to a cached memory location will write data to both the data store 55 and system memory 16. In a write-back configuration, cache controller 18 will write to the data store 55 but the system memory 16 will not be updated. Should the address in data store 55 storing the written data need to be re-used, the line of data at this address is “written back” to system memory 16. Until the write-back occurs, the cached entry at such a location will differ from the corresponding data stored in system memory 16. Typically, a “dirty bit” associates with each line in data store 55 to indicate whether the cached data is the same as the corresponding data stored in system memory 16. To keep system memory 16 updated, cache controller 18 may periodically “flush” data store 55 by writing back all data lines whose dirty bits indicate that the corresponding data stored is system memory 16 are different. It will be appreciated that a parity bit approach to protect against soft errors depends upon the integrity of the data stored in system memory 16. Accordingly, data store 55 may be configured as a write-through or a write-back with a timeout flush cycle to maintain the integrity of system memory 16. After every flush cycle, a timeout period would begin again, whereupon data store 55 is flushed again after the timeout period expires.

While specific examples of the present invention have been shown by way of example in the drawings and are herein described in detail, it is to be understood, however, that the invention is not to be limited to the particular forms or methods disclosed, but to the contrary, the invention is to broadly cover all modifications, equivalents, and alternatives encompassed by the scope of the appended claims.

We claim:

1. A method for error protection of a cache memory, wherein each entry in the tag memory and data store within the cache memory associates with a parity bit, comprising:
(a) providing a read request to a system memory associated with the cache memory, the read request correlating to an entry in the tag memory and the data store;
(b) checking the parity bit associated with the correlated entry in the tag memory and the parity bit associated with the correlated entry in the data store; and
(c) if either act (a) or act (b) indicates an error in the corresponding correlated entry, declaring a miss.

2. The method of claim 1, wherein the cache memory is a second level cache.

3. The method of claim 1, further comprising invalidating the correlated entry in the data store if a miss is declared in act (c).

4. The method of claim 3, wherein act (b) comprises:
checking the parity bit associated with the correlated entry in the tag memory; and
if the parity bit associated with the correlated entry in the tag memory indicates no error:
determining if the correlated entry in the tag memory indicates a hit; and
if there is a hit, checking the parity bit associated with the correlated entry in the data store.

5. The method of claim 4, further comprising:
if the parity bit associated with the correlated entry in the data store indicates no error, retrieving the correlated entry from the data store.

6. The method of claim 5, wherein the retrieving the correlated entry from the data store act comprises retrieving the data line containing the correlated entry.

7. A cache, comprising:
a data store;
a tag memory; and
a parity bit memory configured to store a parity bit for each entry in the data store and for each entry in the tag memory.

8. The cache of claim 7, wherein each entry in the data store has a corresponding entry in the tag memory and wherein the parity bit stored for each entry in the data store is independent from the parity bit for the corresponding entry in the tag memory.

9. The cache of claim 7, wherein each entry in the data store has a corresponding entry in the tag memory and wherein the parity bit memory is configured to store a single parity bit for each data store entry and its corresponding tag memory entry.

10. The cache of claim 7, wherein the cache is configured as a write-through cache.

11. The cache of claim 7, wherein the cache is configured as a write-back cache with a timeout flush.

12. The cache of claim 7, wherein the parity bit memory stores a single parity bit for each cache line in the data store.
